(19) United States
(12) Patent Application Publication
(10) Pub. No.: US 2012/0186094 A1
(43) Pub. Date: Jul. 26, 2012

(54) Drywall finisher's precision cutout template

(76) Inventor: Steven Louis Cornelius, Taft, TN (US)

(21) Appl. No.: 12/930,961

(22) Filed: Jan. 21, 2011

(51) Int. Cl. G01B 1/00

(52) U.S. Cl. 33/528

(57) ABSTRACT

Interchangeable template set for precisely and quickly cutting openings in gypsum, tile, wood paneling or other wall covering material. Floating design and wide variety of available templates (electrical outlets, round water pipe pass-throughs, HVAC duct openings, etc., allows the desired opening to be clearly and quickly marked and the hole cut with very close tolerances to minimize waste material and reduce heating/cooling loss, increasing energy efficiency.

### CROSS REFERENCE TO RELATED APPLICATION

NONE

### STATEMENT REGARDING FEDERALLY SPONSORED RESEARCH OR DEVELOPMENT

No Federal research or development funds were used in the development of this concept/product.

### THE NAMES OF THE PARTIES TO A JOINT RESEARCH AGREEMENT

N/A

### INCORPORATION-BY-REFERENCE OF MATERIAL SUBMITTED ON A COMPACT DISC

N/A

### BACKGROUND OF THE INVENTION

The current tools available for commercial and residential finishing of interior wall surfacing material, e.g., drywall, wood paneling, tile, etc. are the same ones that have been used in general carpentry (measuring tape, utility knife, router, tracing pencil, etc.) for decades. Using these general tools to make precision cuts when installing (hanging) wall material, especially to accommodate known shapes and dimensions such as electrical outlet boxes and plumbing or utility pass-through ports or “runs” through interior walls to finish the interior of a house is very time intensive and the cuts are anything but uniform and precise.

One proposed solution is to use a standard sized electrical wall outlet box constructed of plastic or aluminum box as the cutout template, hereafter known as the “template or template box.” The template box would be threaded to accept telescoping rods with friction locks attached to each of the four sides of the box. Each extension rod would be at least eight feet long and as much as ten feet long and capable of spanning a standard sheet of interior gypsum surfacing material (a standard “drywall” sheet is 4 feet×8 feet in size, but can also be obtained in 4 feet×12 feet lengths). Using the telescoping extension rods to position the electrical box, the template would thus be capable of “floating” to any position on the wall where the 4×8 foot sheet of drywall could be hung. In this way, the exact position of the cutout for an electrical box or other opening could be determined, marked and cut on a blank sheet of drywall or other interior surfacing/finishing material (plywood, gypsum, tile, etc.).

Once the location of the electrical box, other desired fixture or pass-through port has been determined, the Precision Cutout Template is placed where the cutout is desired on the wall and the rods extended to where the edges of a standard sheet of drywall would end and the friction locked used to lock the cutout location into place. The Template is then placed onto the drywall or other surface material, the desired opening marked and the cut made. Time to complete this entire process is less than one minute—even less as the wallboard installer gains experience with the tool. Currently, to measure, transfer measurements, mark and cut an opening takes about five minutes. Using the Precision Cutout template reduces time to measure and cut each outlet hole in a sheet of drywall significantly. Also, the template permits extremely close tolerances between the electrical box or other opening pass-through and the access hole made in the surface material (as little as ⅛^{th} inch). This will greatly reduce finishing time and also prove more energy efficient (less cold air infiltration) and reduce opportunities for insects and other unwanted guests to enter the inside of the dwelling.

This patent submission represents a proposed solution to an on-going construction need.

### FIELD OF THE INVENTION

### Tool—For class 072

A tangible instrumentality having a surface portion which is designed and intended to engage or react against work with sufficient force to effect an operation of the class type. Note. A core, mandrel, anvil, or the like, which may be “passive” in the sense of supplying only reaction force is included in this definition. The tool may be either transitory or enduring; it may be destroyed in a single use.

### (1) DESCRIPTION OF THE RELATED ART INCLUDING INFORMATION DISCLOSED UNDER 37 CFR 1.97 AND CFR1.98

ART UNIT: 2834

### BRIEF SUMMARY OF INVENTION

Modify a standard sized electrical wall outlet box constructed of plastic or aluminum box to act as the cutout template, hereafter known as the “template or template box.” The template box would be threaded to accept telescoping rods with friction locks attached to each of the four sides of the box. Each extension rod would be at least eight feet long and as much as ten feet long and capable of spanning a standard sheet of interior gypsum surfacing material (a standard “drywall” sheet is 4 feet×8 feet in size, but can also be obtained in 4 feet×12 feet lengths). Using the telescoping extension rods to position the electrical box, the template would thus be capable of “floating” to any position on the wall where the 4×8 foot sheet of drywall could be hung. In this way, the exact position of the cutout for an electrical box or other opening could be determined, marked and cut on a blank sheet of drywall or other interior surfacing/finishing material (plywood, gypsum, tile, etc.).

The telescoping extension rod (FIG. 1, items 1a-d, page 17) can be extended as necessary to span several different sizes of drywall sheets. FIG. 1, items 2a-d depict the female threaded receptacles that connect the telescoping positioning rods to the template box. FIG. 1, items 3a-d depict the positioning hooks/tabs which hook over the edge of the sheet of material to be cut, holding the template device firmly in place so that a precise opening in the material may be cut.

### BRIEF DESCRIPTION OF THE SEVERAL VIEWS OF THE DRAWING

FIGS. 1, 1a-d (page 17) depicts a cross section of the entire device, showing the propeller on the front of the wind turbine and the aux engine mounted on the rear of the unit.

1a—extendable positioning rod—maximum length, ten feet

1b—extendable positioning rod—maximum length, ten feet

1c—extendable positioning rod—maximum length, six feet

1d—extendable positioning rod—maximum length, six feet

FIGS. 1, 2a-d (page 17)

2a—threaded female receptacle for extendable positioning rod

2b—threaded female receptacle for extendable positioning rod

2c—threaded female receptacle for extendable positioning rod

2d—threaded female receptacle for extendable positioning rod

FIGS. 1, 3a-d (page 17)

3a—metal hook/clip used to secure extendable positioning rod to the edge of the sheet of drywall or other material to be cut

3b—metal hook/clip used to secure extendable positioning rod to the edge of the sheet of drywall or other material to be cut

3c—metal hook/clip used to secure extendable positioning rod to the edge of the sheet of drywall or other material to be cut

3d—metal hook/clip used to secure extendable positioning rod to the edge of the sheet of drywall or other material to be cut

### (I) DETAILED DESCRIPTION OF THE INVENTION

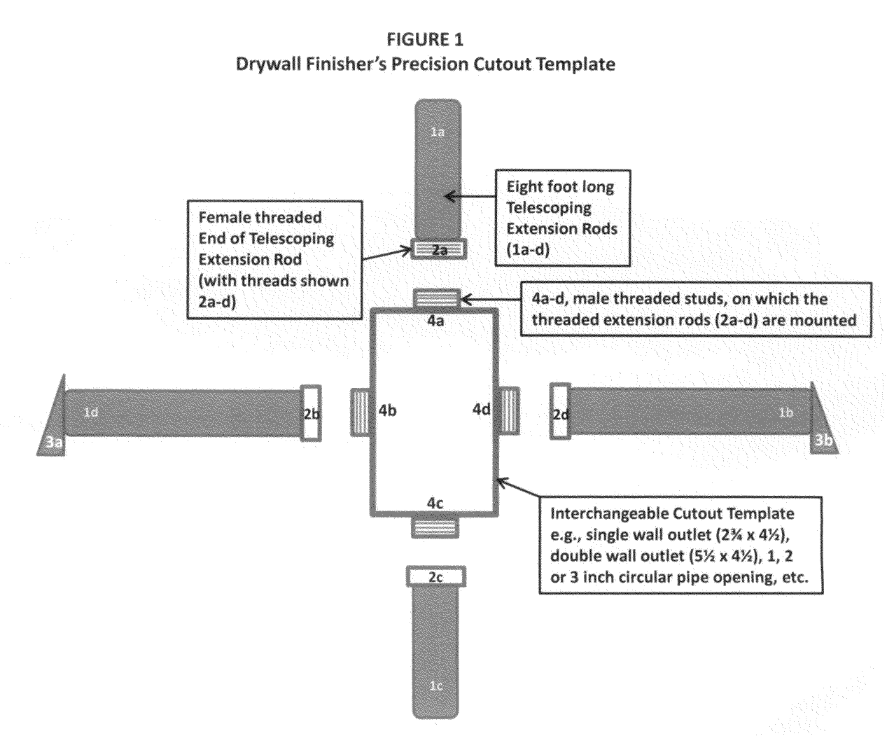

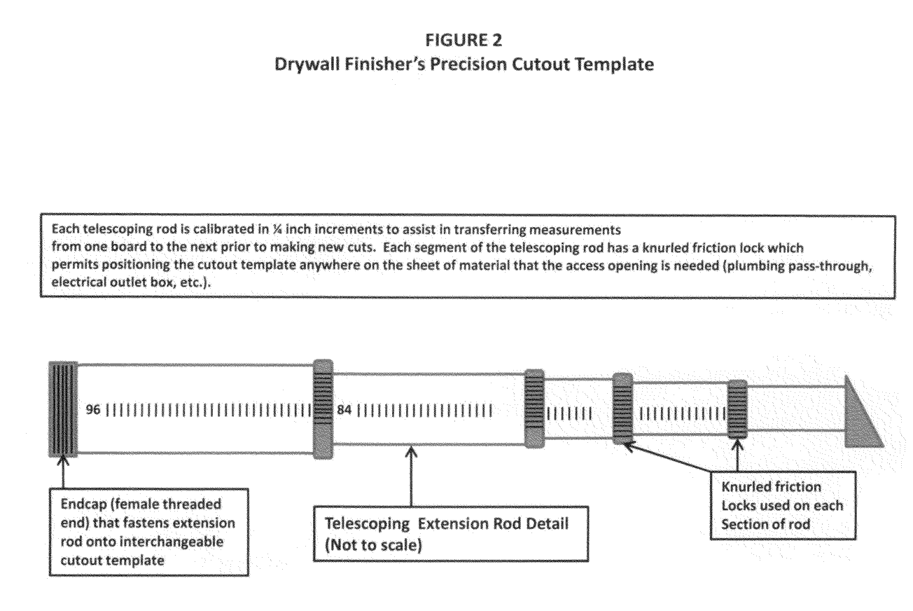

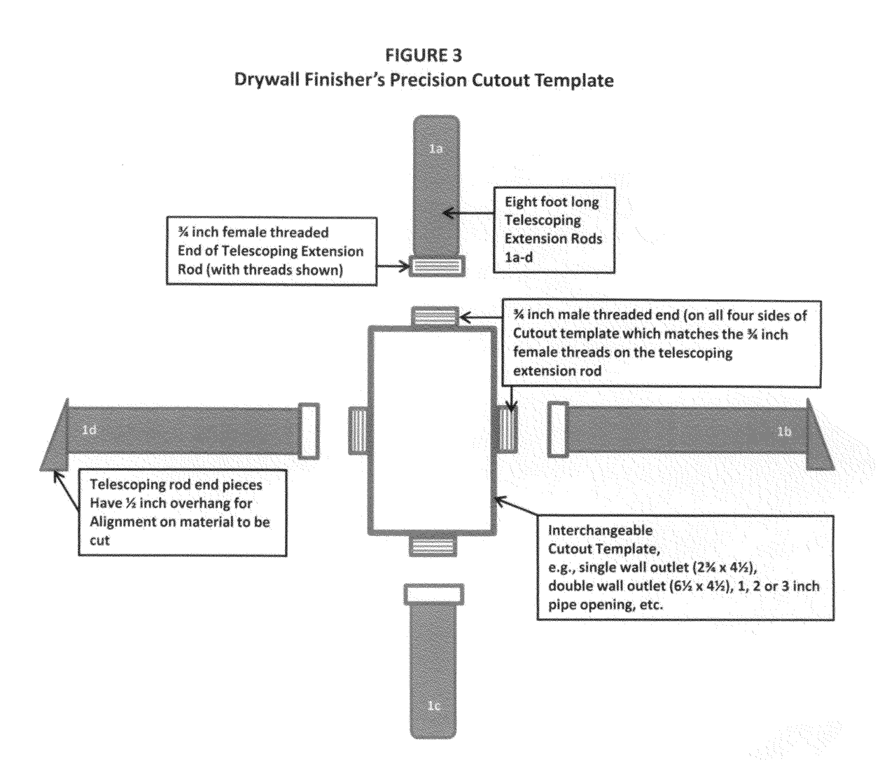

This is a craftsman's template set designed to precisely and quickly guide a worker as he marks openings in wall covering/finishing material during building construction or renovation. The template set consists of a high-impact plastic and cast aluminum assembly, with four extensible aluminum rods, each fitted with a friction lock and metal clips/hook to maintain position on surface edges (see FIG. 1, items 1-4, a through d, page 17).

Templates will consist of a wide variety of “industry standard” sized electrical and plumbing fixtures. For example, single, double, and triple electrical wall outlet boxes, constructed of plastic or aluminum box may be used as the cutout template, hereafter known as the “template or template box.” The template box would be threaded to accept telescoping rods with friction locks attached to each of the four sides of the box. Each extension rod would be at least eight feet long and as much as ten feet long and capable of spanning a standard sheet of interior gypsum surfacing material (a standard “drywall” sheet is 4 feet×8 feet in size, but can also be obtained in 4 feet×12 feet lengths). Using the telescoping extension rods to position the electrical box, the template would thus be capable of “floating” to any position on the wall where the 4×8 foot sheet of drywall could be hung. In this way, the exact position of the cutout for an electrical box, plumbing, HVAC or other opening could be determined, marked and cut on a blank sheet of drywall or other interior surfacing/finishing material (plywood, gypsum, tile, etc.).

Once the location of the electrical box, other desired fixture or pass-through port has been determined, the Precision Cutout Template is placed where the cutout is desired on the wall and the rods extended to where the edges of a standard sheet of drywall would end and the friction locked used to lock the cutout location into place. The Template is then placed onto the drywall or other surface material, the desired opening marked and the cut made.

### (I) SEQUENCE LISTING

### Reference to Sequence Listing, a Table or a Computer Program Listing Compact Disc Appendix

N/A

1. Using this device will save time and enable more precise cuts in sheeting material to be made. Using the telescoping extension rods to position the electrical box, the template would “float” to any position on the wall where the 4×8 or 4×12 foot sheet of drywall could be hung. In this way, the exact position of the cutout for an electrical box or other opening could be determined, marked and cut on a blank sheet of drywall or other interior surfacing/finishing material (plywood, gypsum, tile, etc.).
Time to complete this entire process is less than one minute—even less as the wallboard installer gains experience with the tool. Currently, to measure, transfer measurements, mark and cut an opening in gypsum wallboard takes about five minutes. Using the Precision Cutout template reduces time to measure and cut each outlet hole in a sheet of drywall significantly—as much as 80% (typically, less than one minute). Also, the template permits extremely close tolerances between the electrical box or other opening pass-through and the access hole made in the surface material (as little as ⅛^{th} inch). This will greatly reduce finishing time and also prove more energy efficient (less cold air infiltration) and reduce opportunities for insects and other unwanted guests to enter the inside of the dwelling.
